(19) United States
(12) Patent Application Publication
(10) Pub. No.: US 2014/0139036 A1
(43) Pub. Date: May 22, 2014

(54) WIRELESS POWER TRANSMISSION DEVICE

(71) Applicant: KABUSHIKI KAISHA TOSHIBA, Tokyo (JP)

(72) Inventors: Tetsu SHIJO, Tokyo (JP); Akiko YAMADA, Yokohama-Shi (JP); Shuichi OBAYASHI, Yokohama-Shi (JP)

(73) Assignee: KABUSHIKI KAISHA TOSHIBA, Tokyo (JP)

(21) Appl. No.: 14/081,591

(22) Filed: Nov. 15, 2013

(30) Foreign Application Priority Data
Nov. 19, 2012 (JP) 2012-253441

(51) Int. Cl. H02J 17/00; H01F 38/14

(52) U.S. Cl. CPC H02J 17/00; H01F 38/14
USPC 307/104

(57) ABSTRACT

According to one embodiment, there is provided a wireless power transmission device a magnetic core; a coil wound around the magnetic core; and at least one capacitor connected to the coil, wherein a notched part is formed at a part different from a part around which the coil is wound in the magnetic core, and the capacitor is arranged at the notched part or is arranged so as to be opposed to the notched part.

### CROSS REFERENCE TO RELATED APPLICATIONS

This application is based upon and claims the benefit of priority from the prior Japanese Patent Application No. 2012-253441, filed on Nov. 19, 2012, the entire contents of which are incorporated herein by reference.

### FIELD

Embodiments described herein relate to a wireless power transmission device.

### BACKGROUND

A wireless power transmission device which transmits power by mutual inductance between coils is known. It is often the case that the coil is wound around a magnetic core and a capacitor is connected to the coil. The capacitor is used for resonance of the coil, or is used for matching, for power factor improvement and for inter-terminal voltage reduction by being connected with the coil in series, in parallel, or in a series and parallel combination.

Conventionally, a core structure in which a space is secured by offsetting a coil of a transformer from the center and all or part of a capacitor is arranged in the secured space is known.

However, in a method of arranging the capacitor as described above, there has been a problem that the capacitor influences power transmission between coils causing decline of transmission efficiency.

### BRIEF DESCRIPTION OF THE DRAWINGS

FIG. 1 is a perspective view of a wireless power transmission device according to a first embodiment;

FIG. 2 is a plan view of the wireless power transmission device illustrated in FIG. 1;

FIG. 3 is a drawing illustrating a near electric field distribution of the wireless power transmission device illustrated in FIG. 1;

FIG. 4 is a drawing illustrating a near magnetic field distribution of the wireless power transmission device illustrated in FIG. 1;

FIG. 5 is a drawing illustrating an example of a switch that changes a connection configuration of a capacitor;

FIG. 6 is a drawing illustrating a power receiver in which a subsequent-stage circuit is connected by wiring to the wireless power transmission device illustrated in FIG. 1;

FIG. 7 is a drawing illustrating a configuration in which a rectifier illustrated in FIG. 6 is separated from the subsequent-stage circuit and incorporated in the wireless power transmission device;

FIG. 8 is a drawing illustrating a configuration in which a smoothing capacitor illustrated in FIG. 7 is further separated from the subsequent-stage circuit and incorporated in the wireless power transmission device;

FIG. 9 is a perspective view illustrating a modification example of the wireless power transmission device illustrated in FIG. 1;

FIG. 10 is a plan view illustrating another modification example of the wireless power transmission device illustrated in FIG. 1;

FIG. 11 is a plan view illustrating a configuration of a wireless power transmission device according to a second embodiment of the present invention;

FIG. 12 is a perspective view illustrating another configuration example of the wireless power transmission device according to the first embodiment; and

FIG. 13 is a plan view illustrating a configuration example of a magnetic core.

### DETAILED DESCRIPTION

According to one embodiment, there is provided a wireless power transmission device a magnetic core; a coil wound around the magnetic core; and at least one capacitor connected to the coil.

A notched part is formed at a part different from a part around which the coil is wound in the magnetic core.

The capacitor is arranged at the notched part or is arranged so as to be opposed to the notched part.

Hereinafter, the embodiment will be described in detail with reference to drawings.

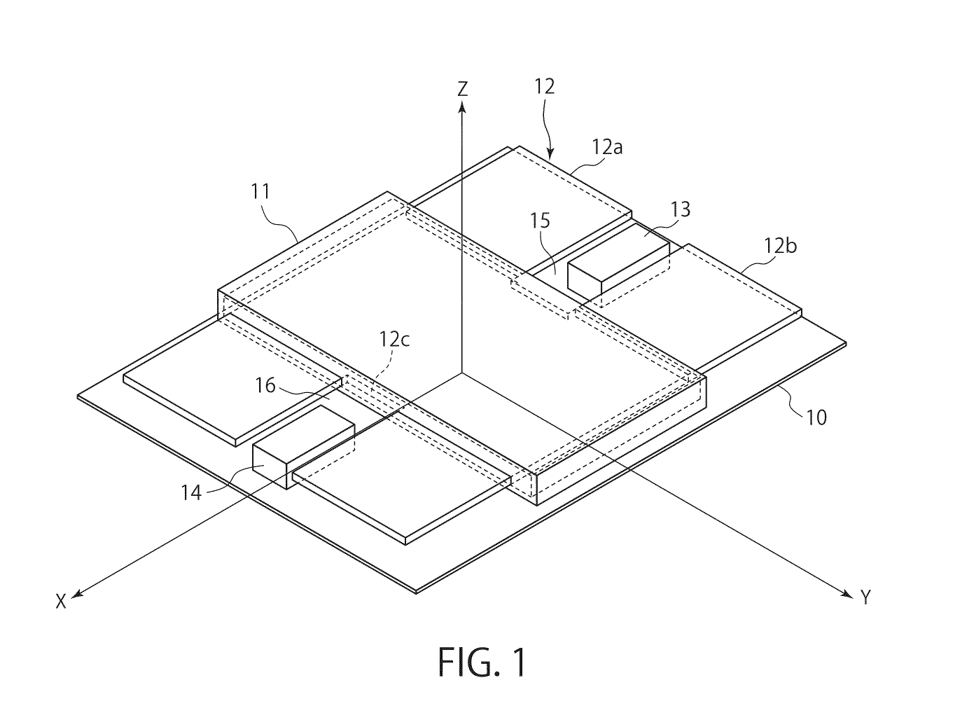

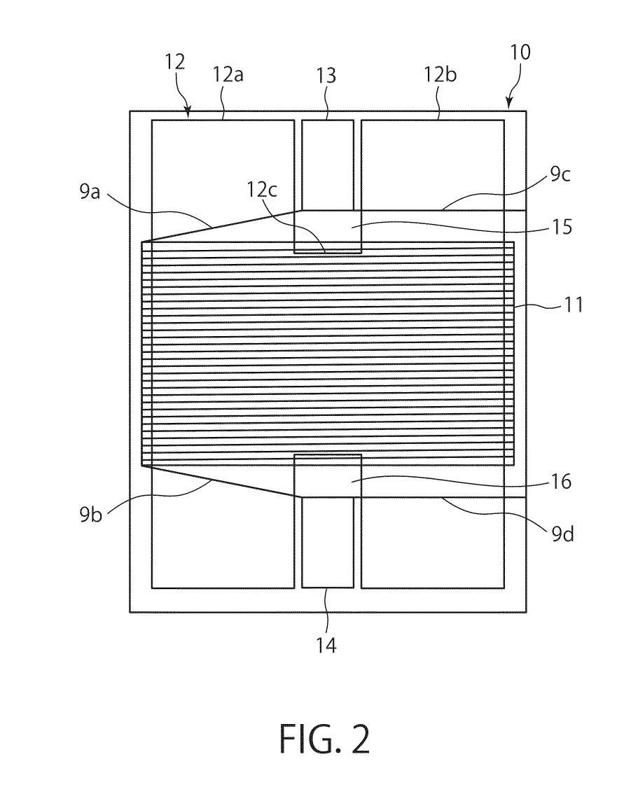

FIG. 1 is a perspective view of a wireless power transmission device according to a first embodiment. FIG. 2 is a plan view of the wireless power transmission device illustrated in FIG. 1. The illustrated wireless power transmission device is a resonator which can be loaded on a power receiver or a power transmitter.

The wireless power transmission device includes a coil 11, a magnetic core 12, capacitors 13 and 14, and a conductor plate 10. The magnetic core 12 is formed of ferrite for instance. The magnetic core 12 may be formed by spreading a plurality of flat rectangular unit blocks or may be formed by one magnetic plate physically. The magnetic core 12 includes a pair of magnetic core blocks 12a and 12b arranged with a gap, and a magnetic core block 12c between the magnetic core blocks 12a and 12b, and the core blocks are integrally formed. In this case, since the magnetic core block 12c has a length shorter than the magnetic core blocks 12a and 12b, notched parts 15 and 16 are formed on the magnetic core 12. Each core block may be formed by spreading the plurality of unit blocks or a magnetic sheet may be used. Also, the magnetic sheets may be piled up to form the magnetic core block or the magnetic core. The magnetic sheets in different sizes may be piled up to form a difference in thickness according to a position of the magnetic core block or the magnetic core.

The coil 11 is wound around the magnetic core 12. The coil 11 is roughly flat. One side face of the coil 11 is mounted on a surface of the conductor plate 10. In a length direction of the coil 11, that is, in a direction vertical to a cross section of the coil 11, the capacitors 13 and 14 are arranged at positions separated from both end faces (opening surfaces) of the coil 11. The end face of the coil is, when the coil is wound vertically to an axis, a surface that passes through an end of the coil and is vertical to the axis, and is the surface that matches an area on the inner side of the coil including the coil.

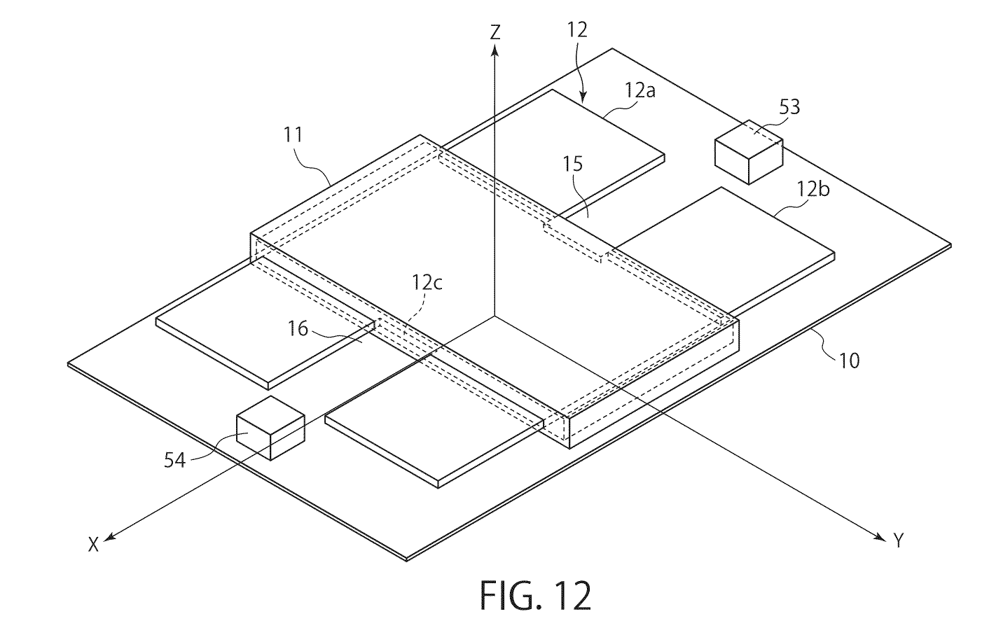

In more detail, the magnetic core 12 has the notched parts 15 and 16 at parts other than the end in a width direction of the coil 11 (the end in a Y axis direction in FIG. 1) among parts different from a part around which the coil 11 is wound. In an example of FIG. 1, the magnetic core 12 has the notched parts 15 and 16 at parts including the end in the length direction of the coil 11 (the end in an X axis direction in FIG. 1). The notched part may be formed so as not to include the end in the length direction of the coil 11 (so as to form a hole in the magnetic core). The capacitors 13 and 14 are arranged at the notched parts 15 and 16. Or, the capacitors 13 and 14 may be arranged so as to be opposed to (or face) the notched parts 15 and 16. That is, the capacitors 13 and 14 may be arranged at positions separated in a direction vertical to the surface of the magnetic core 12 or at positions separated in the X axis direction in a direction horizontal to the surface of the magnetic core 12 from the notched parts 15 and 16. An example of arranging the capacitors at positions separated in the X axis direction horizontally to the surface of the magnetic core 12 is illustrated in FIG. 12. The capacitors 53 and 54 are arranged so as to be opposed to the notched parts 15 and 16 at positions separated in the X axis direction from the magnetic core 12.

The capacitors 13 and 14 are connected at one end to both terminals of the coil 11 through conductive wires 9a and 9b (refer to FIG. 2). The capacitors 13 and 14 are connected at the other end to a circuit not shown in the drawing by conductive wires 9c and 9d, respectively. Specifically, when this wireless power transmission device is loaded on a power receiver, the capacitors 13 and 14 can be connected at the other end to a circuit such as a rectifier. When this wireless power transmission device is loaded on a power transmitter, the capacitors 13 and 14 can be connected at the other end to a circuit such as a power source circuit directly or through another circuit.

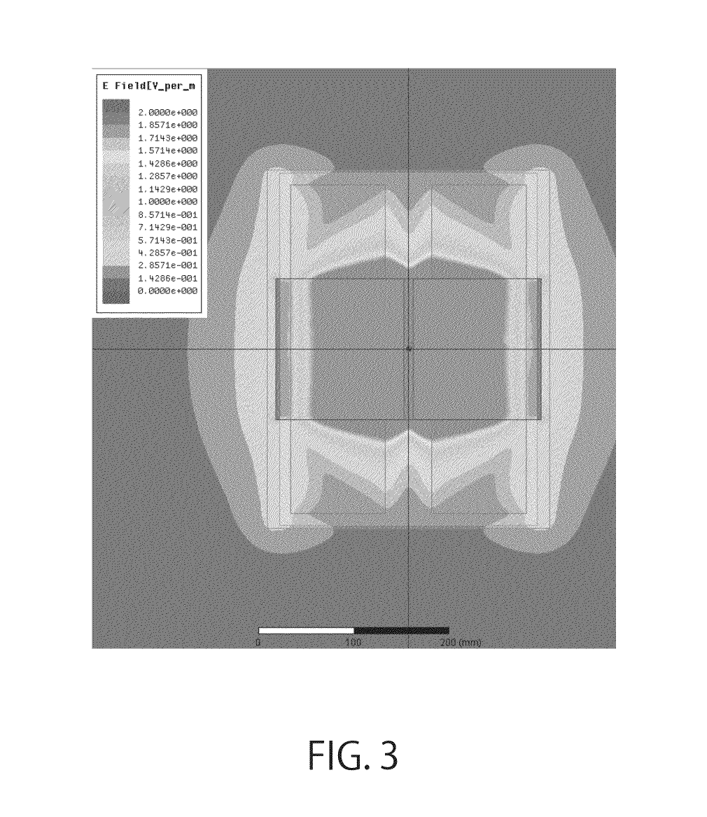

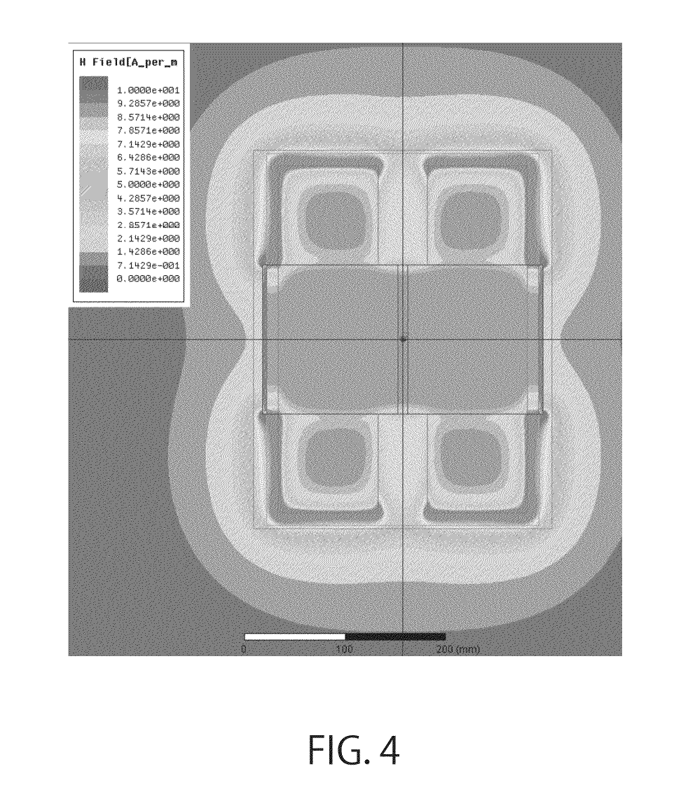

FIG. 3 illustrates a near electric field distribution during an operation of the wireless power transmission device in FIG. 1 and FIG. 2. FIG. 4 illustrates a near magnetic field distribution during the operation of the wireless power transmission device illustrated in FIG. 1 and FIG. 2. The distributions are prepared by results of simulation performed by the inventors.

As a distance from the end face of the coil 11 increases in the length direction of the coil 11, an electromagnetic field distribution formed by the coil 11 becomes weak. While the electromagnetic field becomes weak as separating from the coil 11 in the width direction of the coil 11, a weakening effect of the electromagnetic field distribution is greater when separating in the length direction of the coil 11.

By forming the notched parts 15 and 16 at positions separated in the length direction of the coil 11 and arranging the capacitors 13 and 14 at the notched parts 15 and 16, the capacitors 13 and 14 can be built in the wireless power transmission device while suppressing influence to be exerted on electric characteristics of the coil 11 (coupling characteristics with the coil of a facing wireless power device for instance) and suppressing the overall size to be small. Since the magnetic field distribution of the coil is concentrated on a part where the core is present, by forming the notched part, the magnetic field at the position of the notched part can be made weaker compared to the case of not forming the notched part.

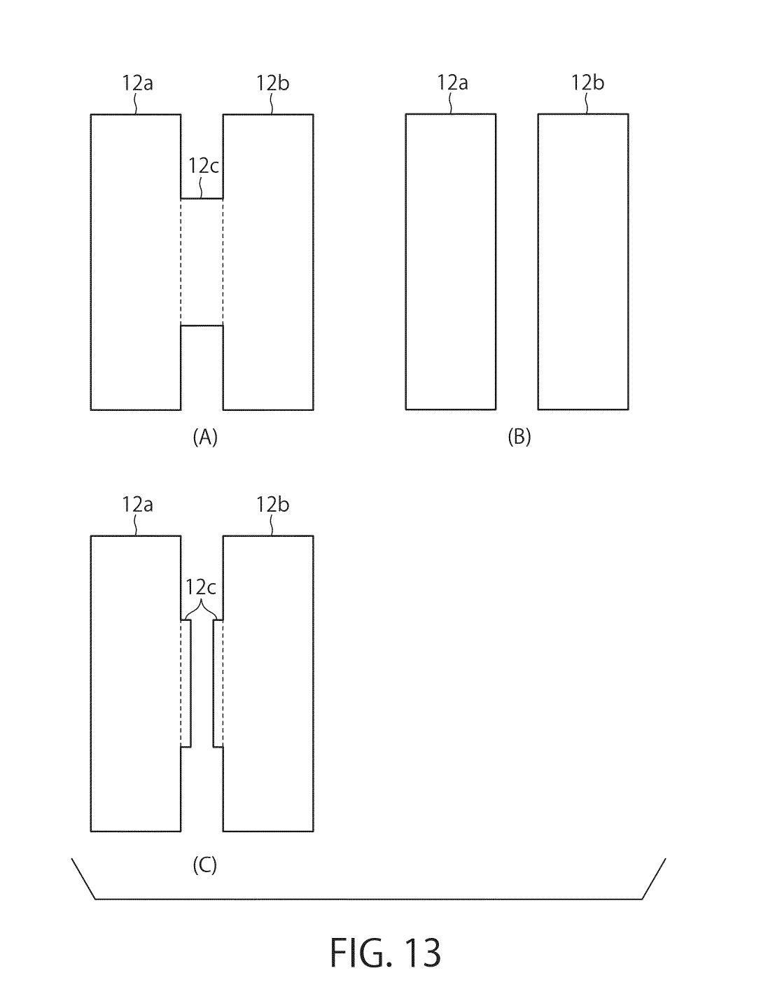

As a modification example of the magnetic core 12, a configuration including only the pair of magnetic core blocks 12a and 12b (refer to FIG. 1 or FIG. 2) arranged with a gap without presence of the magnetic core block 12c is also possible. When the magnetic core block 12c is omitted, even though a core loss reducing effect becomes low, a weight reducing effect can be obtained. By increasing thickness at a position where a magnetic flux density is concentrated (a part around which the coil is wound for instance) in the magnetic core and lowering the magnetic flux density, core loss may be reduced further. FIG. 13(A) is a plan view in which the magnetic core 12 in FIG. 1 and FIG. 2 is taken out and illustrated, and FIG. 13(B) is a plan view of a configuration in which the magnetic core block 12c is removed from the magnetic core 12. As illustrated in FIG. 13(B), the pair of magnetic core blocks 12a and 12b are arranged with a gap. Thus, compared to the configuration in FIG. 13(A), the weight reducing effect can be obtained. Also, while the entire magnetic core block 12c is removed in FIG. 13(B), a part of the magnetic core block 12c may be removed as illustrated in FIG. 13(C).

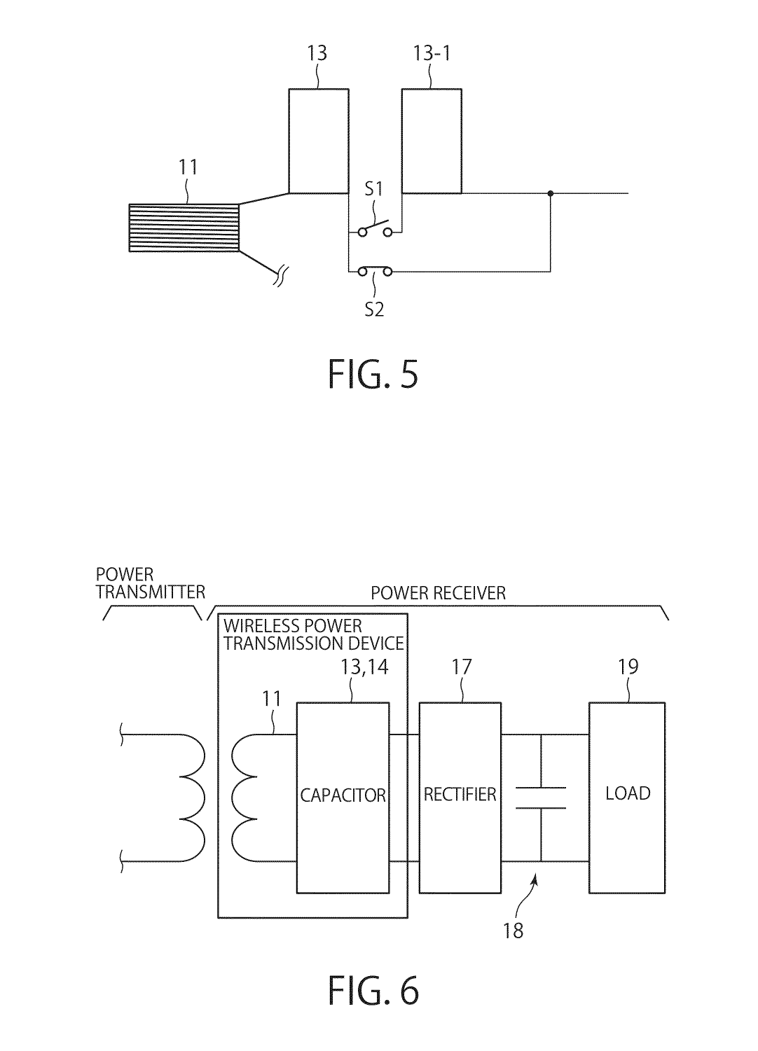

While one capacitor is arranged at one notched part in the example illustrated in FIG. 1 and FIG. 2, a plurality of capacitors may be arranged at one notched part. Also, a switch for selecting one or more of the plurality of capacitors to be connected to the coil 11 may be arranged at the notched part or so as to be opposed to the notched part. For instance, as illustrated in FIG. 5, by changeover of switches S1 and S2, the number of capacitors to be connected may be changed to vary capacitance (capacitance value). Thus, the switch is built in this wireless power transmission device while influence on the electric characteristics of the coil is reduced.

FIG. 6 schematically illustrates a configuration (power receiver) in which a subsequent-stage circuit is connected by wiring to the wireless power transmission device illustrated in FIG. 1 and FIG. 2. The subsequent-stage circuit includes a rectifier 17, a smoothing capacitor 18 and a load 19. Power received from a power transmitter by the wireless power transmission device is converted to a DC by the rectifier 17 and the smoothing capacitor 18 and supplied to the load 19.

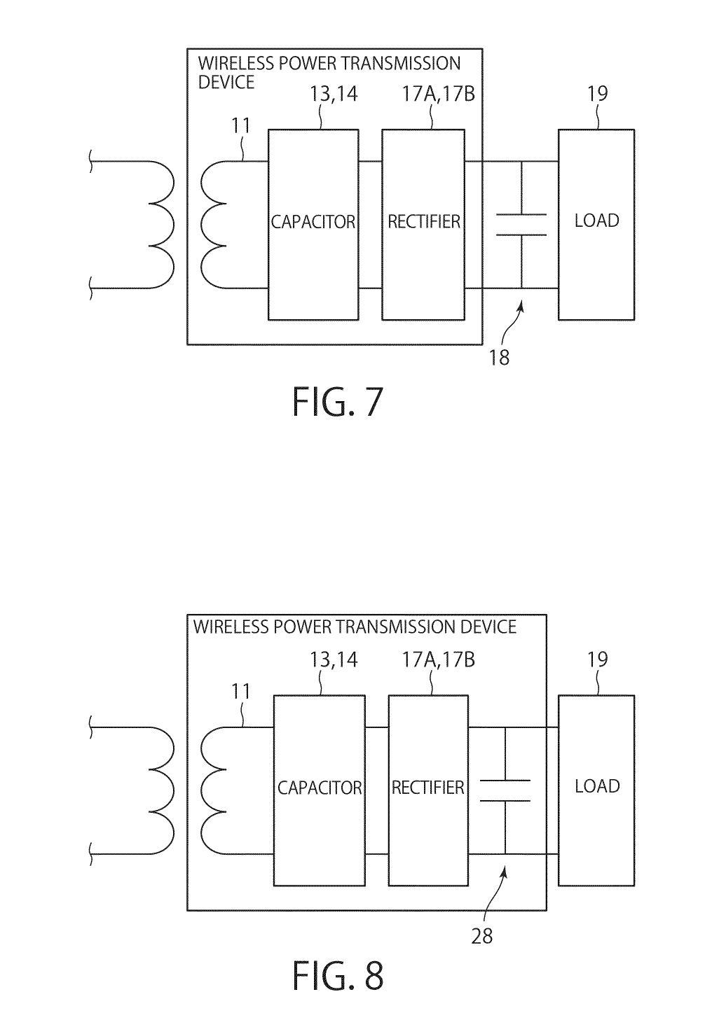

FIG. 7 illustrates a configuration in which the rectifier 17 illustrated in FIG. 6 is separated from the subsequent-stage circuit and incorporated in the wireless power transmission device. The rectifier 17 includes two rectifiers 17A and 17B, and arranged respectively at a position of a weak electromagnetic field distribution similarly to the capacitors 13 and 14. Specifically, the rectifiers 17A and 17B are arranged at the notched parts 15 and 16 illustrated in FIG. 1 or so as to be opposed to the notched parts 15 and 16. The rectifiers 17A and 17B are connected to the capacitors 13 and 14, respectively. Thus, the rectifiers 17A and 17B can be built in the wireless power transmission device while suppressing influence of the electric characteristics on the coil 11 and suppressing the overall size to be small.

FIG. 8 illustrates a configuration in which the smoothing capacitor illustrated in FIG. 7 is further separated from the subsequent-stage circuit and incorporated in the wireless power transmission device. This smoothing capacitor 28 is arranged at the position of the weak electromagnetic field distribution similarly to the description above. Specifically, the smoothing capacitor 18 is arranged at the notched parts 15 and 16 illustrated in FIG. 1 or so as to be opposed to the notched parts 15 and 16. Both terminals of the smoothing capacitor 18 are connected respectively to the rectifiers 17A and 17B. Thus, the smoothing capacitor can be built in the wireless power transmission device while suppressing the influence of the electric characteristics on the coil 11 and suppressing the overall size to be small.

The wireless power transmission device may be attachable and detachable to/from the power receiver and the power transmitter. When the wireless power transmission device is configured to be attachable and detachable, at least the coil 11 and the magnetic core 12, and the capacitors 13 and 14 are configured to be attachable and detachable integrally. By configuring the capacitors 13 and 14 to be attached and detached integrally with the coil 11 and the magnetic core 12, a withstand voltage or a withstand current of a connector used to attach and detach the wireless power transmission device to/from the power receiver and the power transmitter can be lowered.

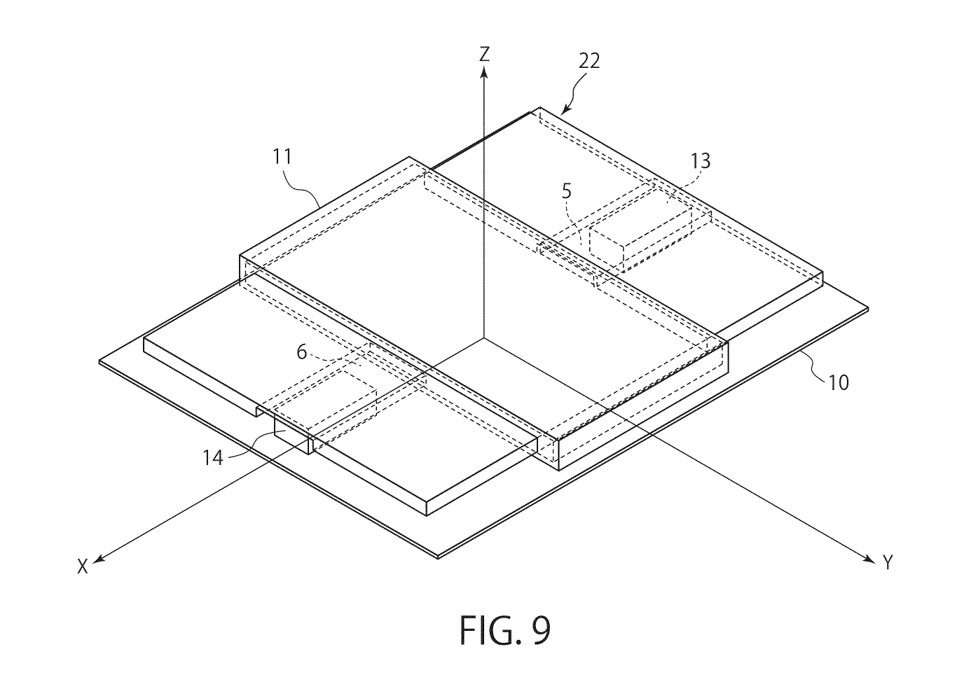

FIG. 9 is a perspective view illustrating a modification example of the wireless power transmission device illustrated in FIG. 1 and FIG. 2.

In the wireless power transmission device illustrated in FIG. 1, the magnetic core 12 is provided with the notched parts 15 and 16. To the contrary, in the device illustrated in FIG. 9, thickness of the magnetic core 22 is reduced at positions corresponding to the notched parts 15 and 16 in FIG. 1. That is, in the magnetic core 12, the thickness of block parts 5 and 6 which are portions of the part different from the part around which the coil 11 is wound is made thinner than the other part, especially the part around which the coil 11 is wound. Specially, a thinned part is formed at the part other than the end in the width direction of the coil 11 (the end in the Y axis direction in FIG. 1). In the example in FIG. 9, the magnetic core 22 has the thinned part formed at the part including the end in the length direction of the coil 11 (the end in the X axis direction in FIG. 1). By reducing the thickness, the distribution of a magnetic field at the part is weakened, also a space is secured, and the capacitors 13 and 14 are arranged in the open space. Thus, while suppressing decline of magnetic coupling with the facing wireless power transmission device, the influence to be exerted on the electric characteristics of the coil 11 can be suppressed, and the overall size can be suppressed to be small further.

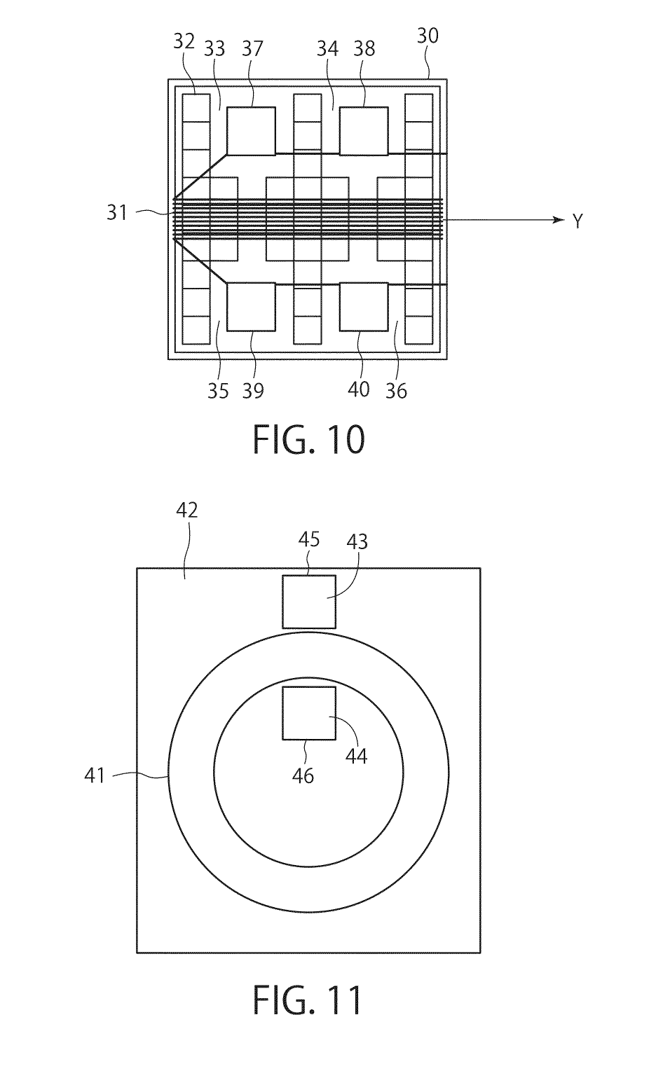

FIG. 10 is a plan view illustrating another modification example of the wireless power transmission device illustrated in FIG. 1 and FIG. 2.

While there are two notched parts in the magnetic core and there are two capacitors in the wireless power transmission device illustrated in FIG. 1, in this modification example, there are four notched parts 33, 34, 35 and 36 in a magnetic core 32.

At the four notched parts 33, 34, 35 and 36, capacitors 37, 38, 39 and 40 are arranged. The capacitors 37, 38, 39 and 40 are mounted on a conductor plate 30. One end of the capacitor 37 is connected to one end of a coil 31, and one end of the capacitor 39 is connected to the other end of the coil 31.

One end of the capacitor 38 is connected to the other end of the capacitor 37. That is, the capacitor 37 and the capacitor 38 are connected in series. The other end of the capacitor 38 is connected to a circuit not shown in the drawing.

One end of the capacitor 40 is connected to the other end of the capacitor 39. That is, the capacitor 39 is connected with the capacitor 40 in series. The other end of the capacitor 40 is connected to the circuit not shown in the drawing.

The circuit not shown in the drawing is, for instance, a circuit such as a rectifier in the case of a power receiver or is a circuit such as a power supply generation circuit in the case of a power transmitter.

In an area of the notched parts 33, 34, 35 and 36, as described above, the electromagnetic field distribution of the coil 11 is weak. Thus, by arranging the capacitors at the notched parts 33, 34, 35 and 36, the overall size (width and thickness) can be suppressed to be small while suppressing the influence on the electric characteristics of the coil 31.

While four pieces of notched parts and four pieces of capacitors are illustrated in this example, implementation is possible similarly in the cases of three pieces, five pieces and six or more pieces as well.

Also, while one capacitor is arranged at one notched part, the plurality of capacitors may be arranged at one notched part.

As previously described, at one notched part, the rectifier, the smoothing capacitor, the switch that switches capacitor connection, or any combination thereof may be arranged.

In a configuration in FIG. 10, the number of the notched parts and the number of the capacitors are two each holding the coil 31 therebetween, and a symmetrical structure is provided. This embodiment is not limited to that and may be an asymmetrical structure in which, for instance, one notched part and one capacitor are on one side of the coil and two notched parts and two capacitors are on the opposite side.

FIG. 11 is a plan view illustrating a configuration of a wireless power transmission device according to the second embodiment of the present invention.

On a surface of a magnetic core 42, a coil (horizontally wound coil) 41 is arranged. One of both end faces of the coil 41 is in contact with the magnetic core 42. In the magnetic core 42, a notched part 46 is formed at a core part on the inner side of the coil 41, and a notched part 45 is formed at a core part on the outer side of the coil 41. A capacitor 43 is arranged at the notched part 45, and a capacitor 44 is arranged at the notched part 46. In the illustrated example, a planar shape and size of the notched part are roughly the same as a planar shape and size of the capacitor. The capacitor can be arranged so as to be opposed to the notched part.

One end of the coil 41 is taken out from the inner side of the coil 41 and connected to one end of the capacitor 44. The other end of the coil 41 is taken out to the outer side of the coil 41 and connected to one end of the capacitor 43. The other end of the capacitor 43 and the other end of the capacitor 44 are connected to a circuit not shown in the drawing.

Since the electromagnetic field distribution by the coil 41 is concentrated in an area where the magnetic core is present, by arranging the capacitors 43 and 44 at the notched parts 45 and 46, the influence of the electric characteristics to be exerted on the coil 41 can be suppressed, and a device size can be suppressed.

Instead of the notched parts 45 and 46, the thickness of a core block at the part may be reduced to arrange the capacitor at the thinned part or so as to be opposed to the part.

The present invention is not limited only to the above-described embodiments as they are, and may be specifically implemented with modified components without departing from the scope in the implementation stage. Also, by appropriate combination of the plurality of components disclosed in, the above-described embodiments, various inventions can be formed. For instance, some components may be eliminated from the whole components described in the embodiments. Further, components over different embodiments may be combined accordingly.

1. A wireless power transmission device comprising:
a magnetic core;
a coil wound around the magnetic core; and
at least one capacitor connected to the coil,
wherein
a notched part is formed at a part different from a part around which the coil is wound in the magnetic core, and
the capacitor is arranged at the notched part or is arranged so as to be opposed to the notched part.

2. The device according to claim 1,
wherein the notched part is formed at a part not including an end in a width direction of the coil in the magnetic core.

3. The device according to claim 2,
wherein the notched part is formed at a part including an end in a length direction of the coil in the magnetic core.

4. The device according to claim 1, further comprising a diode for rectification connected to the capacitor,
wherein the diode is arranged at the notched part or is arranged so as to be opposed to the notched part.

5. The device according to claim 4, further comprising a smoothing capacitor connected to the diode,
wherein the smoothing capacitor is arranged at the notched part or is arranged so as to be opposed to the notched part.

6. The device according to claim 1, comprising:
a plurality of capacitors; and
a switch selecting one or more of the capacitors to be connected to the coil,
wherein the capacitors and the switch are arranged at the notched part or are arranged so as to be opposed to the notched part.

7. A wireless power transmission device comprising:
a magnetic core;
a coil wound around the magnetic core; and
at least one capacitor connected to the coil,
wherein
a part different from a part around which the coil is wound in the magnetic core is made at least partially thinner than the part around which the coil is wound, and
the capacitor is arranged at the thinned part of the magnetic core or is arranged so as to be opposed to the part.

8. The device according to claim 7,
wherein the thinned part is a part not including an end in a width direction of the coil in the magnetic core.

9. The device according to claim 8,
wherein the thinned part is a part including an end in a length direction of the coil in the magnetic core.

10. The device according to claim 7, comprising a diode for rectification connected to the capacitor,
wherein the diode is arranged at the thinned part or is arranged so as to be opposed to the part.

11. The device according to claim 10, further comprising a smoothing capacitor connected to the diode for rectification,
wherein the smoothing capacitor is arranged at the thinned part or is arranged so as to be opposed to the part.

12. The device according to claim 7, comprising:
a plurality of capacitors; and
a switch selecting one or more of the capacitors to be connected to the coil,
wherein the capacitors and the switch are arranged at the thinned part or are arranged so as to be opposed to the part.

13. A wireless power transmission device comprising:
first and second magnetic core blocks arranged with a gap;
a coil wound around the first and second magnetic core blocks; and
at least one capacitor connected to the coil,
wherein the capacitor is arranged at a part different from a part around which the coil is wound in the gap between the first and second magnetic core blocks or is arranged so as to be opposed to the part.

14. The device according to claim 13, comprising a diode for rectification connected to the capacitor,
wherein the diode is arranged at the part different from the part around which the coil is wound in the gap between the first and second magnetic core blocks or is arranged so as to be opposed to the part.

15. The device according to claim 14, further comprising a smoothing capacitor connected to the diode for rectification,
wherein the smoothing capacitor is arranged at the part different from the part around which the coil is wound in the gap between the first and second magnetic core blocks or is arranged so as to be opposed to the part.

16. The device according to claim 13, comprising:
a plurality of capacitors at least one of which is the at least one capacitor; and
a switch configured to switch connection between the capacitors,
wherein the capacitors and the switch are arranged at the part different from the part around which the coil is wound in the gap between the first and second magnetic core blocks or are arranged so as to be opposed to the part.

17. A wireless power transmission device comprising:
a magnetic core;
a coil, one of end faces of the coil being in contact with the magnetic core; and
at least one capacitor connected to the coil,
wherein
a notched part is formed at a core part inside or outside the coil in the magnetic core, and
the capacitor is arranged at the notched part or is arranged so as to be opposed to the notched part.
